(19) United States
(12) Patent Application Publication
(10) Pub. No.: US 2020/0088060 A1
(43) Pub. Date: Mar. 19, 2020

(54) ROTARY DETONATION ROCKET ENGINE GENERATOR

(71) Applicant: Donald Gene Taylor, Kamas, UT (US)

(72) Inventor: Donald Gene Taylor, Kamas, UT (US)

(21) Appl. No.: 16/133,400

(22) Filed: Sep. 17, 2018

(51) Int. Cl. F01D 15/10; H02K 7/18

(52) U.S. Cl. CPC F01D 15/10; H02K 7/1823

(57) ABSTRACT

A rotary detonation rocket engine generator system comprises an axial drive shaft coupled to an electrical generator, two support arms extending radially from the axial drive shaft, and two detonation rocket engines supported at by the support arms. In response to ignition and combustion of a fuel supplied to the detonation rocket engines, a thrust force from the detonation rocket engines causes rotation of the axial drive shaft to drive the electrical generator. Fuel (and optionally other fluids) can be supplied through channels of the axial drive shaft and the support arms to the detonation rocket engines. A housing can enclose the detonation rocket engines, the support arms, and a portion of the axial drive shaft, which can be oriented vertically. One or more support arms and associated detonation rocket engines can be incorporated into a particular assembly. A method of producing electricity with the generator system is provided.

### BACKGROUND

Generating electricity, particularly on a large industrial scale, has various challenges depending on the particular system implemented. Coal and fossil fuel power plants suffer from pollution issues, and typically include complex systems that have a number of energy losses and have high startup and operating costs. Nuclear power plants also suffer from pollution issues, and require high startup, high operating costs, and complex systems that also have a number of energy losses and other issues to address. Clean energy generator systems, such as wind, hydroelectric, and solar generated power systems, are not always reliable in terms of available clean energy to convert to electrical energy. Such alternative energy systems can also be complex and consume a large area of land to produce relatively small amounts of electricity compared to traditional fuel power plants.

### SUMMARY

The present disclosure sets forth a rotary detonation rocket engine generator system comprising an axial drive shaft operably coupled to an electrical generator, at least one support arm coupled to and extending radially from the axial drive shaft, and at least one detonation rocket engine supported at an end of the at least one support arm. In response to ignition and combustion of a fuel supplied to the at least one detonation rocket engine, a thrust force generated by the at least one detonation rocket engine causes rotation of the axial drive shaft to drive the electrical generator.

In one example, the at least one support arm comprises opposing support arms, and the at least one detonation rocket engine comprises opposing detonation rocket engines each coupled to a respective one of opposing support arms.

In one example, the axial drive shaft comprises an axial fluid channel extending through the axial drive shaft, and wherein the opposing support arms each include a radial fluid channel in fluid communication with the axial fluid channel and the opposing detonation rocket engines, such that the radial fluid channels and the fluid conduit define a fuel supply line which supplies the fuel to the opposing detonation rocket engines.

In one example, the detonation engine assembly further comprises a rotary union device coupled to the axial drive shaft which transfers fuel from a fuel source and into the axial fluid channel of the axial drive shaft.

In one example, the opposing detonation rocket engines comprise a pair of detonation rocket engines, and the opposing support arms comprise a pair of support arms coupled to and extending generally orthogonally from the axial drive shaft and supporting respective detonation rocket engines, such that the detonation rocket engines are separated from each other by approximately 180 degrees.

In example, the rotary detonation rocket engine generator system further comprises a housing that encloses the at least one detonation rocket engine, the at least one support arm, and at least a portion of the axial drive shaft.

In one example, the housing further comprises a fluid outlet configured to allow removal of exhaust products from within the housing.

The present disclosure sets forth a method of producing electricity comprising supplying a fuel to at least one detonation rocket engine radially coupled to an axial drive shaft, and igniting the fuel to cause combustion in the at least one detonation rocket engine to generate a thrust force that causes the at least one detonation rocket engine to rotate the axial drive shaft, which generates electrical energy with an electrical generator coupled to the axial drive shaft.

In another example, the method further comprises supplying oxygen through oxygen supply channels of the axial drive shaft and of at least one support arm coupling the at least one detonation rocket engine to the axial drive shaft. The operation of supplying the fuel to the at least one detonation rocket engine comprises supplying fuel through fuel supply channels of the axial drive shaft and of the at least one support arm.

In one example, the operation of supplying the fuel to the at least one detonation rocket engine comprises transferring the fuel through a fuel inlet of a rotary union device fluidly coupling a fuel source to an axial fuel channel of the axial drive shaft.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1A is an isometric view of a rotary detonation rocket engine generator system, and showing certain components schematically in accordance with an example of the present disclosure.

FIG. 1B is a side cross sectional view of the system of FIG. 1A.

FIG. 2 is a side cross sectional view of a detonation rocket engine that could be incorporated with the system of FIG. 1A, in accordance with an example of the present disclosure.

FIG. 3 is an isometric view of a portion of the system of FIG. 1A, showing an axial drive shaft and detonation rocket engine coupled together by a support arm.

FIG. 4 is a cross sectional view of the support arm of FIG. 3, and taken across lines 4-4.

FIG. 5 is a top down view of a portion of a rotary detonation rocket engine generator system, and showing four support arms and four detonation rocket engines for rotating an axial drive shaft, in accordance with an example of the present disclosure.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

In describing and claiming the present invention, the following terminology will be used.

The singular forms “a,” “an,” and “the” include plural referents unless the context clearly dictates otherwise. Thus, for example, reference to “a support” includes reference to one or more of such materials and reference to “expanding” refers to one or more such steps.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of” For example, “at least one of A, B and C” explicitly includes only A, only B, only C, and combinations of each.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

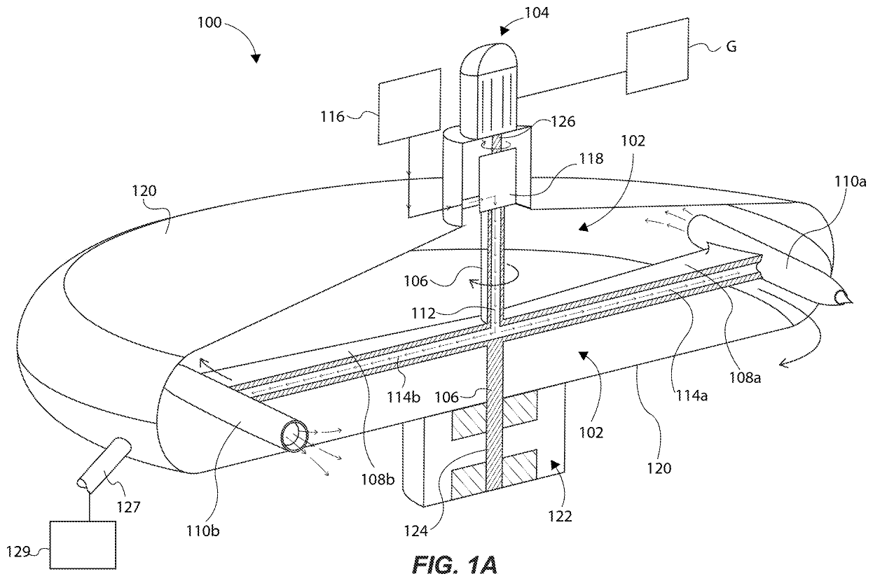

FIGS. 1A and 1B illustrate a rotary detonation rocket engine generator system 100 in accordance with an example of the present disclosure. As an overview, the rotary detonation rocket engine generator system 100 can comprise a detonation engine assembly 102 coupled to an electrical generator 104 for generating electrical power, such as for supplying to a power grid G, battery storage, site power generation, or the like. The detonation engine assembly 102 can comprise an axial drive shaft 106 coupled to the electrical generator 104. The detonation engine assembly 102 can comprise support arms 108a and 108b coupled to and extending radially from the axial drive shaft 106. Opposing detonation rocket engines 110a and 110b can be supported at distal ends of the opposing support arms 108a and 108b. Alternatively, if an odd number of support arms and detonation rocket engines are used, the support arms can be circumferentially evenly distributed. Regardless, in response to ignition and combustion of a fuel supplied to each of the detonation rocket engines 110a and 110b, a thrust force is generated by each of the opposing detonation rocket engines 110a and 110b, which causes rotation of the axial drive shaft 106 to drive the electrical generator 104.

More specifically, and in one example, the axial drive shaft 106 can comprise an axial fluid channel 112 that extends through the axial drive shaft 106. The opposing support arms 108a and 108b can include respective radial fluid channels 114a and 114b in fluid communication with the axial fluid channel 112 and with fuel inlets of respective detonation rocket engines 110a and 110b. A fuel supply source 116 can be operatively coupled to the axial drive shaft 106 in a manner such that a fuel line from the fuel supply source 116 is in fluid communication with the axial fluid channel 112, and therefore with the radial fluid channels 114a and 114b and the detonation rocket engines 110a and 110b. A rotary union device 118 can be coupled to the axial drive shaft 106 and to the fuel line of the fuel supply source 116 in a manner to transfer fuel, oxygen, hydrogen, and/or steam from the fuel supply source 116 into the axial fluid channel 112 of the axial drive shaft 106. In this way, the axial drive shaft 106 can be coupled to one side (or input component) of the rotary union device 118 in a suitable manner, while an output drive shaft 126 can be coupled to the other side (or output component) of the rotary union device 118 and coupled to the electrical generator 104. The rotary union device 118 is shown schematically as a box for illustration clarity, and because rotary union devices for supplying one or more of fluid, gas, fuel, etc. through one or more lines into a rotating component (e.g., axial drive shaft 106) are well known in the industry, and can be complex systems, and therefore will not be discussed or shown in detail herein. However, some non-limiting examples of rotary unions that could be used include rotary unions supplied by Dynamic Sealing Technologies, Inc., Stenring, Inc., Kadant, Inc., and others. Note that the output drive shaft 126 would normally rotate at the same rate as rotation of the axial drive shaft 106, because the rotary union device 118 transfers such rotational energy from one shaft to another shaft (or to an outer sleeve), as with typical rotary union devices.

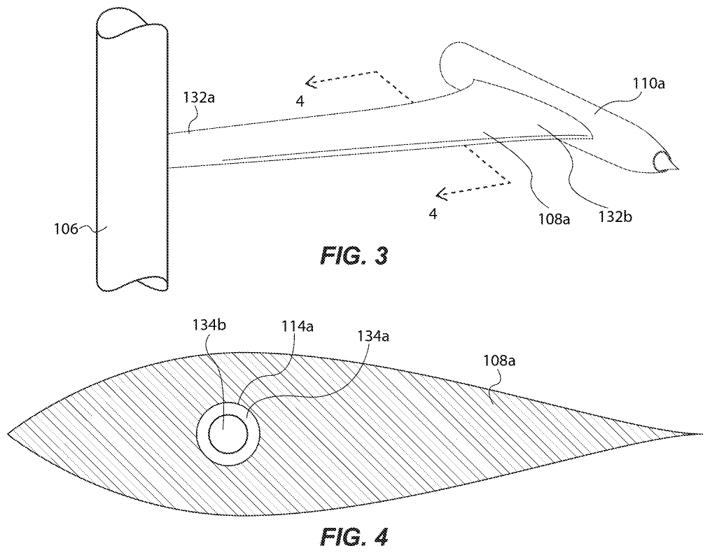

The fuel supply source 116 can comprise different fuel, fluid or gas supply sources and systems for separately (or collectively) supplying fuel, air, oxygen, steam, or other fluids from the fuel supply source 116, through the rotary union device 118, and into the axial fuel channel 112. Accordingly, one or more separate fluid flow lines may be defined by a flow path from the fuel supply source 116 through the axial fuel channel 112 and through each of the radial fluid channels 114a and 114b for separately supplying fuel and oxygen, for instance, to inlets of the detonation rocket engines 110a and 110b for detonation (see e.g., the below discussion regarding FIG. 4). Alternatively to the fuel supply system shown in FIGS. 1A and 1B, the radial fluid channels 114a and 114b can be replaced with external fuel supply lines attached to an outer surface of the support arms 108a and 108b. In another example, the fuel and oxygen (or other fluids) can be combined at the fuel supply source 116, and then transferred via a single supply flow path through the rotary union device 118, the axial drive shaft 106, each of the support arms 108a and 108b, and to the detonation rocket engines 110a and 110b for combustion.

The rotary detonation rocket engine generator system 100 can further comprise a housing 120 that encloses the opposing detonation rocket engines 110a and 110b, the opposing support arms 108a and 108b, and at least a portion of the axial drive shaft 106. A bearing assembly 122 can be attached to a lower side of the housing 120 for supporting a lower end section 124 of the axial drive shaft 106 (or the lower end section 124 can be a separate shaft coupled to the axial drive shaft 106 proximate the coupling interface of the support arms and the axial drive shaft). Another bearing assembly (not shown) can be optionally supported at an opposing side of the housing 120 for rotatably supporting the axial drive shaft 106, or the rotary union device 118 can act as a bearing for an upper end of the axial drive shaft 106.

In one example, the housing 120 can comprise an exhaust outlet 127 configured to allow removal of exhaust products from within the housing 120 that are exhausted from the detonation rocket engines 110a and 110b. Exhaust products can be removed through the exhaust outlet 127 either passively (e.g., pressure differentials between ambient and within the housing), or actively using an exhaust device 129, such as a pump, induction blower, or steam induction device. In one aspect, the exhaust products can be biofiltered before storage, sequestering, release, heat recovery, or further processing.

In the examples discussed herein, aerodynamic consistency can be enhanced by providing a housing (e.g., housing 120), which can be large enough to allow rotation of detonation rocket engine(s) without interference or creation of undesirable aerodynamic fluid flows within the housing.

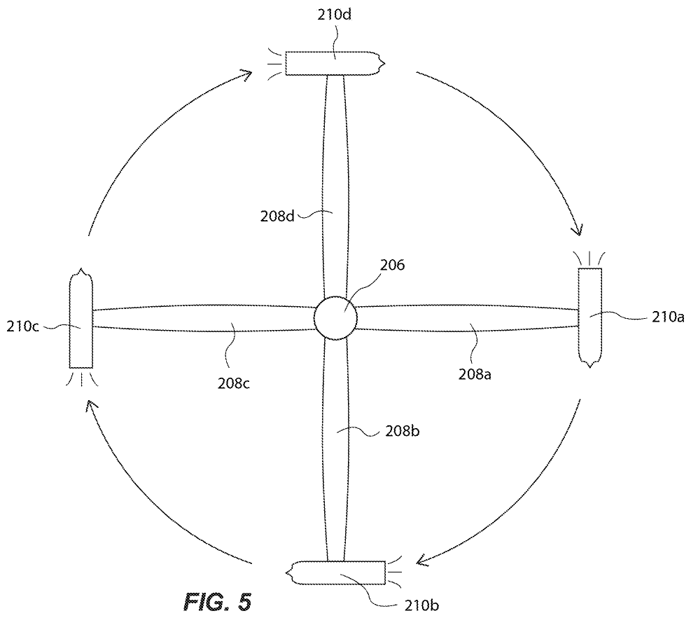

As shown best in FIG. 1A, the opposing support arms 108a and 108b and the attached opposing detonation rocket engines 110a and 110b can extend orthogonally and radially (outwardly) from the axial drive shaft 106 in opposite directions from each other, such that the opposing detonation rocket engines 110a and 110b are radially situated approximately 180° away from each other and perpendicular to the axial drive shaft 106. In another example, the support arms of a particular system could extend downwardly or upwardly at an angle (non-perpendicular angle) relative to a longitudinal axis of the axial drive shaft 106. In other examples, more than two opposing detonation rocket engines can be incorporated into a particular detonation engine assembly (see e.g., FIG. 5). For example, three, four or five opposing detonation rocket engines can be radially distributed at 120°, 90°, or 72°, respectively, such that detonation rocket engines are evenly distributed circumferentially around the axial drive shaft 106. In other examples, more than five opposing detonation rocket engines can be incorporated, such as up to twelve or more. In this way, the term “opposing” detonation rocket engines can mean directly opposite each other, or it can mean three or more detonation rocket engines that oppose each other via even and balanced circumferential radial distribution, such as being adjacent and separated by 90°, which could be four “opposing” detonation rocket engines. In another example, only one detonation rocket engine may be incorporated into a particular generator, in which case a counterbalancing mass can be mounted to an opposing arm from the support arm that supports the one detonation rocket engine.

In operation and with continued reference to FIGS. 1A and 1B, one or more fluids (e.g., oxygen and fuel) are supplied from the fuel supply source 116, through the rotary union device 118, through the axial fluid channel 112, through the radial fluid channels 114a and 114b, and then injected into fuel inlets of the detonation rocket engines 110a and 110b. Once injected, the fuel can be ignited and combusted, and then exhausted out the nozzles of the detonation rocket engines 110a and 110b, which generates a thrust force that causes the detonation rocket engines 110a and 110b to move forward. Such forward thrust imparts a rotational force on the axial drive shaft 106 via the detonation rocket engines 110a and 110b being constrained to the axial drive shaft 106 by the support arms 108a and 108b. Such rotation of the axial drive shaft 106 generates electricity via the electrical generator 104.

In one example, as shown in FIG. 1B, the axial drive shaft 106 can be oriented generally vertically or orthogonally relative to the earth or a ground surface, while the support arms 108a and 10b can be oriented generally horizontal or parallel to the earth or a ground surface. This vertical configuration of the axial drive shaft 106 can reduce asymmetric stresses in the axial drive shaft 106 (and other rotational components) because a gravitational force would be acting more uniformly on the rotating components as compared to being oriented off-vertical.

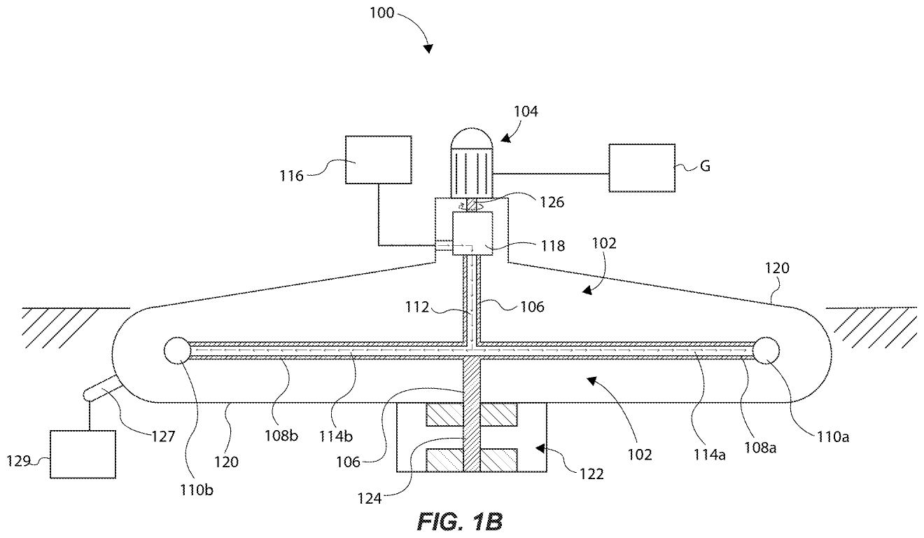

A particular detonation rocket engine can be a continuous detonation rocket engine, a pulse detonation rocket engine, a ramjet rocket engine, or a scramjet rocket engine. In one specific example, the detonation rocket engine can be a linear detonation combustor. For example, one or more linear tubes can be arrayed in parallel to provide detonation tubes which are optionally arranged with one-way valves and interconnections to control detonation wave paths. In one alternative, the linear detonation combustor can have an annular array of parallel linear detonation tubes. FIG. 2 shows a cross sectional view of one example of a detonation rocket engine 128 that can be incorporated with the system of FIGS. 1A and 1B (and FIG. 5). The detonation rocket engine 128 can include a rocket body 130, an air inlet 132, an inner body 134, a diffuser 136, and fuel sprayers 138 that can be coupled to the fuel supply source 116 via the aforementioned fuel supply lines. An igniter 140 can be positioned adjacent the fuel sprayers 138 for ignition and combustion of the fuel in a combustion chamber 142, so that combusted gases exit through a nozzle 144 and out of the detonation rocket engine 128 for expansion of exhaust gases, which produces thrust of the detonation rocket engine 128. It should be appreciated by those skilled in the art that suitable detonation rocket engines can be incorporated with the systems described herein for generating subsonic or supersonic rotational movement of the detonation rocket engines and the axial drive shaft.

The detonation rocket engines exemplified herein can have aerodynamic leading portion (e.g., FIG. 2) proximate the air inlet, which increases transfer of energy from combustion and expansion into momentum of the detonation rocket engines and support arms while minimizing aerodynamic friction resistance. This is particularly useful for supersonic rocket engines that benefit from supersonic airflow into the rocket engine, like scramjets and ramjets. The expansion outlets (e.g., nozzles 144) can be contoured to optimize thrust upon exit of gases from the detonation rocket engine. In one aspect, the expansion outlet can be a de Laval configuration, although other nozzle contours and throat configurations can be used.

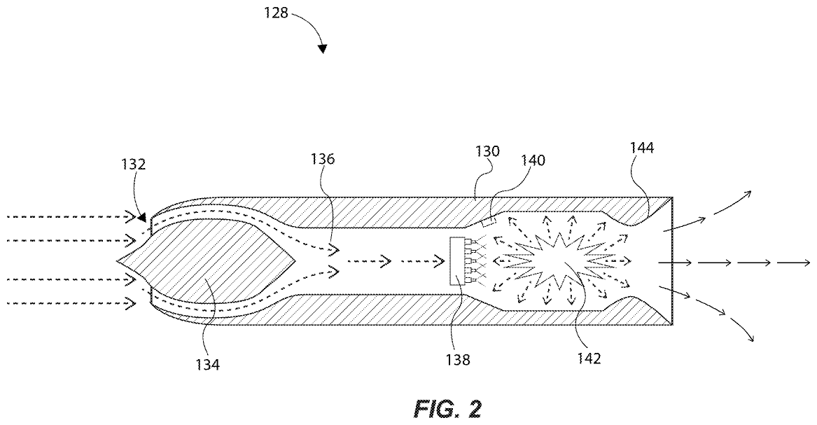

FIG. 3 shows the support arm 108a and the detonation rocket engine 110a attached to the axial drive shaft 106. Any suitable devices can be used to attach a detonation rocket engine to a support arm, such as brackets, fasteners, welding, etc., as well as any suitable attachment mechanisms to secure the other ends of the support arms to the axial drive shaft. In one example, a manifold housing (not shown) can be used to couple the axial drive shaft 106 to opposing support arms, so that fuel and/or oxygen can be effectively transferred from the axial fuel channel to the radial fuel channels.

In one example, the support arm 108a (and 108b) can comprise an aerodynamic cross-sectional profile, which is also shown in the cross sectional view of FIG. 4. In this way, the support arm 108a can move through the air with minimal wind drag forces, which improves efficiency of the system (as compared to using round bar support arms, for instance). The aerodynamic cross-sectional profile can also be tapered in an outward or radial direction from a first end 132a proximate the axial drive shaft 106 to a second end 132b proximate the detonation rocket engine 110a. This tapered configuration provides the advantages of reducing mass of the system while providing sufficient structural support to the rocket engines, which maximizes efficiency while reducing weight.

FIG. 4 shows a cross sectional view of the support arm 110a, which illustrates that the radial fuel channel 114a that can comprise or support a pair of coaxially aligned supply lines 134a and 134b. The first supply line 134a can supply fuel (e.g., rocket fuel, hydrogen, etc.) to the detonation rocket engine 110a, while the second supply line 134b can supply oxygen to the detonation rocket engine 110a for mixture with the fuel and combustion. In another example, more than two supply lines could be incorporated. Alternatively, one supply line may be provided to transfer a mixture of fuel and oxygen (or other mixture) from the fuel supply source 116 through the single supply line and to the rocket engines for ignition and detonation. Note that the support arms can be substantially hollow to reduce mass, as opposed to the substantially solid body shown in FIG. 4, depending on system design requirements.

FIG. 5 shows a top down view of a portion of a rotary detonation rocket engine generator system that includes an axial drive shaft 206, four opposing support arms 208a-d coupled to and radially extending from the axial drive shaft 206, and four opposing detonation rocket engines 210a-d supported at ends of respective support arms 208a-d. In this example, the opposing detonation rocket engines 210a-d are separated from each other by approximately 90 degrees, and can be similarly configured as described regarding FIG. 1A in terms of detonation and generating thrust to rotate the axial drive shaft 206 to produce electricity. It should be appreciated that the components shown in FIG. 5 can be incorporated with components of the system 100 of FIGS. 1A and 1B, namely the housing 120, the rotary union device 118, the fuel supply source 116, for generating electrical power.

Note that the support arms exemplified herein can be any length, and in one example, can define a rotational diameter of about 15 feet to about 50 feet, although smaller or larger diameters may be designed with appropriate consideration for rotational stresses and material limitations, depending on the desired generator output and intended application.

Non-limiting examples of suitable fuel that can be supplied to the detonation rocket engines include natural gas, hydrogen gas, hydrogen-carbon monoxide gas, landfill gases, biogas, jet fuel, or micronized solid fuels, including powered biomass or powered coal, and combinations thereof. In one aspect, the fuel can be pyrolysis gas, resulting from the thermal chemical conversion of solid fuels into fuel-gases. In examples where steam is supplied, steam can be provided from any suitable source. Although not required, high temperature, high pressure steam can provide sufficient efficiencies. For example, temperatures from about 100° C. to about 700° C. and pressures from about 10 atm to about 200 atm can be used. In one alternative, the steam can be produced from formation of a coal gasification synthesis gas. Other steam sources can include, but are not limited to, waste heat recovery, nuclear fission, and the like. The steam to fuel mass ratio can be adjusted and can generally range from about 1:1 to about 20:1. Similarly, the oxygen fuel mixture ratio will typically be operated with the stoichiometric amount of oxygen or with excess oxygen. Oxygen can be provided via air or oxygen enriched air, although other oxygen sources or oxygen-containing gases can be used. In one aspect, the oxygen fuel stoichiometric ratio can range from about 1 to about 7. In one alternative, the fluid can be a compressed gas which is allowed to expand through the rotary expanders in the absence of combustion.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A rotary detonation rocket engine generator system for producing electrical energy, comprising:
an axial drive shaft operably coupleable to an electrical generator;
at least one support arm coupled to and extending radially from the axial drive shaft; and
at least one detonation rocket engine supported at an end of the at least one support arm, wherein, in response to ignition and combustion of a fuel supplied to the at least one detonation rocket engine, a thrust force generated by the at least one detonation rocket engine causes rotation of the axial drive shaft to drive the electrical generator to produce electrical energy.

2. The rotary detonation rocket engine generator system of claim 1, wherein the at least one support arm comprises opposing support arms, and wherein the at least one detonation rocket engine comprises opposing detonation rocket engines each coupled to a respective one of opposing support arms.

3. The rotary detonation rocket engine generator system of claim 2, wherein the axial drive shaft comprises an axial fluid channel extending through the axial drive shaft, and wherein the opposing support arms each include a radial fluid channel in fluid communication with the axial fluid channel and the opposing detonation rocket engines, such that the radial fluid channels and the axial fluid channel define a fuel supply line which supplies the fuel to the opposing detonation rocket engines.

4. The rotary detonation rocket engine generator system of claim 3, further comprising a rotary union device coupled to the axial drive shaft which transfers fuel from a fuel source and into the axial fluid channel of the axial drive shaft.

5. The rotary detonation rocket engine generator system of claim 3, wherein the axial fluid channel and the radial fluid channels each include at least two dedicated channels for parallel transport of fuel and oxygen to the opposing detonation rocket engines.

6. The rotary detonation rocket engine generator system of claim 2, wherein the opposing support arms define a rotational diameter from about 15 feet to about 50 feet.

7. The rotary detonation rocket engine generator system of claim 2, wherein the opposing detonation rocket engines comprise a pair of detonation rocket engines, and wherein the opposing support arms comprise a pair of support arms coupled to and extending generally orthogonally from the axial drive shaft and supporting respective detonation rocket engines, such that the detonation rocket engines are separated from each other by approximately 180 degrees.

8. The rotary detonation rocket engine generator system of claim 2, wherein the opposing detonation rocket engines comprise at least three detonation rocket engines separated substantially equally from each other around a circumferential envelope defined by rotary motion of the at least three detonation rocket engines.

9. The rotary detonation rocket engine generator system of claim 8, wherein the at least three detonation rocket engines include from three to eight detonation rocket engines.

10. The rotary detonation rocket engine generator system of claim 1, wherein the at least one detonation rocket engine comprises one of a continuous detonation rocket engine, a pulse detonation rocket engine, a ramjet rocket engine, or a scramjet rocket engine.

11. The rotary detonation rocket engine generator system of claim 1, wherein the at least one detonation rocket engine comprises a linear detonation combustor.

12. The rotary detonation rocket engine generator system of claim 1, wherein the at least one support arm has an aerodynamic cross-sectional profile.

13. The rotary detonation rocket engine generator system of claim 12, wherein the aerodynamic cross-sectional profile is tapered in a radial direction from proximate the axial drive shaft to the at least one detonation rocket engine supported by the at least one support arm.

14. The rotary detonation rocket engine generator system of claim 1, further comprising a housing that encloses the at least one detonation rocket engine, the at least one support arm, and at least a portion of the axial drive shaft.

15. The rotary detonation rocket engine generator system of claim 14, wherein the housing further comprises a fluid outlet configured to allow removal of exhaust products from within the housing.

16. The rotary detonation rocket engine generator system of claim 1, wherein the axial drive shaft is configured to be oriented vertically relative to a ground surface during operation.

17. The rotary detonation rocket engine generator system of claim 1, wherein the at least one detonation rocket engine comprises a pair of detonation rocket engines, and wherein the at least one support arm comprises a pair of support arms coupled to the axial drive shaft and extending in generally opposite directions from each other about the axial drive shaft, wherein each of the axial drive shaft and the pair of support arms comprise an oxygen supply channel and a fuel supply channel for supplying fuel and oxygen to the pair of detonation rocket engines.

18. The rotary detonation rocket engine generator system of claim 1, further comprising a fuel supply source in fluid communication with the at least one detonation rocket engine, and further comprising the electrical generator coupled to the axial drive shaft.

19. A method of producing electricity, comprising:
supplying a fuel to at least one detonation rocket engine radially coupled to an axial drive shaft; and
igniting the fuel to cause combustion in the at least one detonation rocket engine to generate a thrust force that causes the at least one detonation rocket engine to rotate the axial drive shaft, which generates electrical energy with an electrical generator coupled to the axial drive shaft.

20. The method of claim 19, further comprising supplying oxygen through oxygen supply channels of the axial drive shaft and of at least one support arm coupling the at least one detonation rocket engine to the axial drive shaft, wherein supplying the fuel to the at least one detonation rocket engine comprises supplying fuel through fuel supply channels of the axial drive shaft and of the at least one support arm.

21. The method of claim 19, wherein supplying the fuel to the at least one detonation rocket engine comprises transferring the fuel through a fuel inlet of a rotary union device fluidly coupling a fuel source to an axial fuel channel of the axial drive shaft.

22. The method of claim 19, further comprising a power generator comprising the at least one detonation rocket engine, the axial drive shaft, and the electrical generator, the power generator further comprising at least one support arm coupled to and extending radially from the axial drive shaft, wherein each of the axial drive shaft and the at least one support arm comprise an oxygen supply channel and a fuel supply channel for supplying fuel and oxygen to the at least one detonation rocket engine.
